(19) United States
(12) Patent Application Publication
(10) Pub. No.: US 2025/0085461 A1
(43) Pub. Date: Mar. 13, 2025

(54) Actuator for a Tunable Lens

(71) Applicant: Apple Inc., Cupertino, CA (US)

(72) Inventors: Matthew D Hollands, Cambridge (GB); Richard J Topliss, Cambridge (GB); James E Pedder, Oxon (GB); Daniel J Burbridge, Cambridge (GB)

(21) Appl. No.: 18/753,992

(22) Filed: Jun. 25, 2024

Related U.S. Application Data
(60) Provisional application No. 63/581,922, filed on Sep. 11, 2023.

(51) Int. Cl. G02B 3/14

(52) U.S. Cl. CPC G02B 3/14

(57) ABSTRACT

An electronic device may include a lens module with a tunable lens. The tunable lens may include a flexible lens element and a lens shaping structure attached to the flexible lens element. The lens shaping structure may include a plurality of tabs that are each coupled to a respective actuator. The actuator may have a slot that receives the tab of the lens shaping structure and moves the tab up and down along an axis of displacement. The actuator may include two motor subassemblies that each have a ring-shaped magnet between two coils. The actuator may include a housing, a screw that is rotated by the motor subassemblies, a guide rod, and a nut with openings aligned with both the screw and the guide rod. The actuator may include a homing sensor with an electrode on the nut and at least one electrode on the housing.

This application claims the benefit of U.S. provisional patent application No. 63/581,922, filed Sep. 11, 2023, which is hereby incorporated by reference herein in its entirety.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users' heads. The head-mounted devices may include optical systems with lenses.

Head-mounted devices typically include lenses with fixed shapes and properties. If care is not taken, it may be difficult to adjust these types of lenses to optimally present content to each user of the head-mounted device.

### SUMMARY

An actuator may include a housing, a screw in the housing, a nut in the housing and aligned with the screw, a stepper motor in the housing and configured to rotate the screw to adjust a position of the nut, and a capacitive sensor configured to sense a position of the nut. The capacitor sensor may include a first electrode on the nut and at least one electrode on the housing.

A tunable lens may include a lens element and an actuator configured to adjust a first position of the lens element. The actuator may include a screw, a nut aligned with the screw, and first and second motor subassemblies configured to rotate the screw. The first position of the lens element and a second position of the nut may be adjusted when the screw is rotated and each one of the first and second motor subassemblies may include a ring-shaped magnet with a plurality of sections having alternating polarity, a first coil, and a second coil. The ring-shaped magnet may be interposed between the first and second coils.

An actuator may include a housing, a screw enclosed by the housing, a nut enclosed by the housing and aligned with the screw, a stepper motor enclosed by the housing and configured to rotate the screw to adjust a position of the nut, and a homing sensor configured to sense when the nut is at a known home position. The homing sensor may include a conductive bar that moves in unison with the nut and at least one electrode on a wall of the housing.

### BRIEF DESCRIPTION OF THE DRAWINGS

FIG. 1 is a schematic diagram of an illustrative electronic device in accordance with some embodiments.

FIG. 2 is a top view of an illustrative head-mounted device with a lens module in accordance with some embodiments.

FIG. 3 is a side view of an illustrative lens module in accordance with some embodiments.

FIGS. 4 and 5 are side views of an illustrative tunable lens in different tuning states in accordance with some embodiments.

FIG. 6 is a top view of an illustrative tunable lens with a lens shaping structure in accordance with some embodiments.

FIG. 7A is a perspective view of an illustrative motor subassembly in accordance with some embodiments.

FIG. 7B is a cross-sectional side view of the illustrative motor subassembly of FIG. 7A in accordance with some embodiments.

FIG. 7C is a top view of an illustrative ring-shaped magnet that may be used in the motor subassembly shown in FIGS. 7A and 7B in accordance with some embodiments.

FIG. 7D is a side view of an actuator that includes two motor subassemblies of the type shown in FIGS. 7A and 7B in accordance with some embodiments.

FIG. 7E is a top view of the actuator of FIG. 7D in accordance with some embodiments.

FIG. 8A is a view of an illustrative homing sensor for an actuator when the electrode attached to the nut of the actuator is in a home position in accordance with some embodiments.

FIG. 8B is a view of an illustrative homing sensor for an actuator when the electrode attached to the nut of the actuator is above a home position in accordance with some embodiments.

FIG. 8C is a view of an illustrative homing sensor for an actuator when the electrode attached to the nut of the actuator is below a home position in accordance with some embodiments.

FIG. 9A is a top view of an illustrative nut with an electrode for a homing sensor that is formed from a T-shaped piece of metal that is inserted into a slot in the nut in accordance with some embodiments.

FIG. 9B is a top view of an illustrative nut with an electrode for a homing sensor that is formed from a flat piece of metal that is attached to the nut with adhesive in accordance with some embodiments.

FIG. 9C is a top view of an illustrative nut with an electrode for a homing sensor that is plated directly on the nut in accordance with some embodiments.

FIG. 9D is a top view of an illustrative nut with an electrode for a homing sensor that is overmolded with plastic for the nut in accordance with some embodiments.

FIG. 9E is a top view of an illustrative nut with an electrode for a homing sensor that is formed from the nut itself in accordance with some embodiments.

FIGS. 10A-10C are views of illustrative position sensors with resolution across the entire actuator range in accordance with some embodiments.

### DETAILED DESCRIPTION

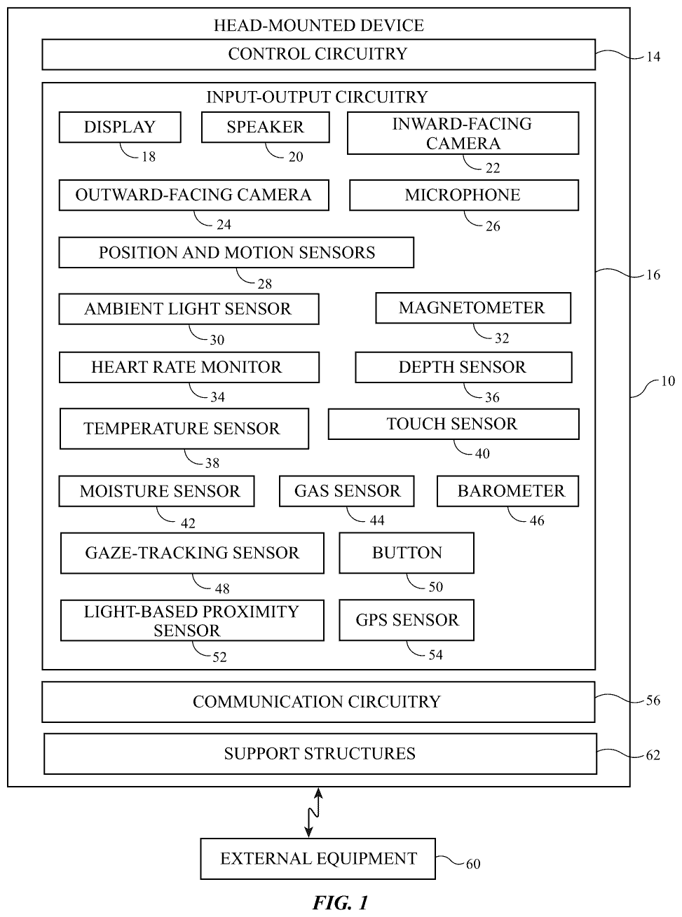

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 18 may be omitted from device 10 if desired. Device 10 may include an optical pass-through area where real-world content is viewable to the user either directly or through a tunable lens.

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gases (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHZ and 5 GHz Wi-Fi® (IEEE 802.11) bands, wireless personal area network (WPAN) communications bands such as the 2.4 GHZ Bluetooth® communications band, cellular telephone communications bands such as a cellular low band (LB) (e.g., 600 to 960 MHZ), a cellular low-midband (LMB) (e.g., 1400 to 1550 MHZ), a cellular midband (MB) (e.g., from 1700 to 2200 MHz), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHZ), satellite navigations bands (e.g., an LI global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHZ and/or a second UWB communications band at 8.0 GHZ), and/or any other desired communications bands.

The radio-frequency transceiver circuitry may include millimeter/centimeter wave transceiver circuitry that supports communications at frequencies between about 10 GHz and 300GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHZ and 40 GHz, a Kᵤ communications band between about 12 GHZ and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHZ), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with external equipment 60. External equipment 60 may include one or more external servers, an electronic device that is paired with head-mounted device 10 (such as a cellular telephone, a laptop computer, a speaker, a computer monitor, an electronic watch, a tablet computer, earbuds, etc.), a vehicle, an internet of things (IoT) device (e.g., remote control, light switch, doorbell, lock, smoke alarm, light, thermostat, oven, refrigerator, stove, grill, coffee maker, toaster, microwave, etc.), etc.

Electronic device 10 may have housing structures (e.g., housing walls, straps, etc.), as shown by illustrative support structures 62 of FIG. 1. In configurations in which electronic device 10 is a head-mounted device (e.g., a pair of glasses, goggles, a helmet, a hat, etc.), support structures 62 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support control circuitry 14, input-output circuitry 16, and/or communication circuitry 56.

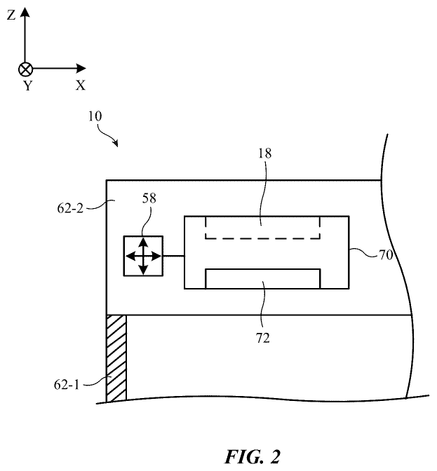

FIG. 2 is a top view of electronic device 10 in an illustrative configuration in which electronic device 10 is a head-mounted device. As shown in FIG. 2, electronic device 10 may include support structures (see, e.g., support structures 62 of FIG. 1) that are used in housing the components of device 10 and mounting device 10 onto a user's head. These support structures may include, for example, structures that form housing walls and other structures for main unit 62-2 (e.g., exterior housing walls, lens module structures, etc.) and eyeglass temples or other supplemental support structures such as structures 62-1 that help to hold main unit 62-2 on a user's face.

The electronic device may include optical modules such as optical module 70. The electronic device may include left and right optical modules that correspond respectively to a user's left eye and right eye. An optical module corresponding to the user's left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user's eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 14 during operation of device 10. For example, positioners 58 may be used to adjust the spacing between modules 70 (and therefore the lens-to-lens spacing between the left and right lenses of modules 70) to match the interpupillary distance IPD of a user's eyes. In another example, the lens module may include an adjustable lens element. The curvature of the adjustable lens element may be adjusted in real time by positioner(s) 58 to compensate for a user's eyesight and/or viewing conditions.

Each optical module may optionally include a display such as display 18 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

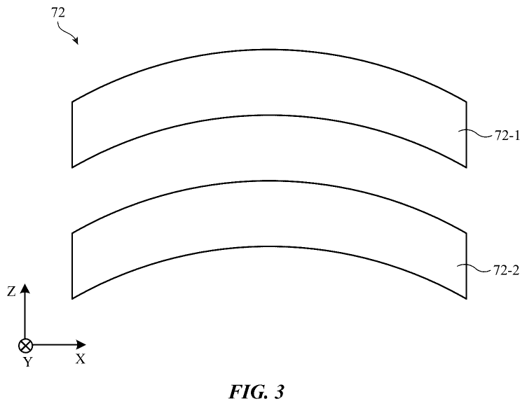

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), a combination of convex and concave surfaces, or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions and/or curvatures defined by polynomial series and expansions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 18 and an opposing concave surface. Lens element 72-2 has a convex surface that faces lens element 72-1 and an opposing concave surface.

One or both of lens elements 72-1 and 72-2 may be adjustable. In one example, lens element 72-1 is a non-adjustable lens element whereas lens element 72-2 is an adjustable lens element. The adjustable lens element 72-2 may be used to accommodate a user's eyeglass prescription, for example. The shape of lens element 72-2 may be adjusted if a user's eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amounts and orientations of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

In one possible arrangement, lens element 72-1 may be a removable lens element. In other words, a user may be able to easily remove and replace lens element 72-1 within optical module 70. This may allow lens element 72-1 to be customizable. If lens element 72-1 is permanently affixed to the lens assembly, the lens power provided by lens element 72-1 cannot be easily changed. However, by making lens element 72-1 customizable, a user may select a lens element 72-1 that best suits their eyes and place the appropriate lens element 72-1 in the lens assembly. The lens element 72-1 may be used to accommodate a user's eyeglass prescription, for example. A user may replace lens element 72-1 with an updated lens element if their eyeglass prescription changes (without needing to replace any of the other components within electronic device 10). Lens element 72-1 may have varying lens power and/or may provide varying amount of astigmatism correction to provide prescription correction for the user. Lens element 72-1 may include one or more attachment structures that are configured to attach to corresponding attachment structures included in optical module 70, lens element 72-2, support structures 26, or another structure in electronic device 10.

In contrast with lens element 72-1, lens element 72-2 may not be a removable lens clement. Lens clement 72-2 may therefore sometimes be referred to as a permanent lens element, non-removable lens element, etc. The example of lens element 72-2 being a non-removable lens element is merely illustrative. In another possible arrangement, lens element 72-2 may also be a removable lens element (similar to lens element 72-1).

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to as lens elements. In other words, adjustable lens element 72-2 (sometimes referred to as adjustable lens module 72-2, adjustable lens 72-2, tunable lens 72-2, etc.) may be formed by multiple respective lens elements.

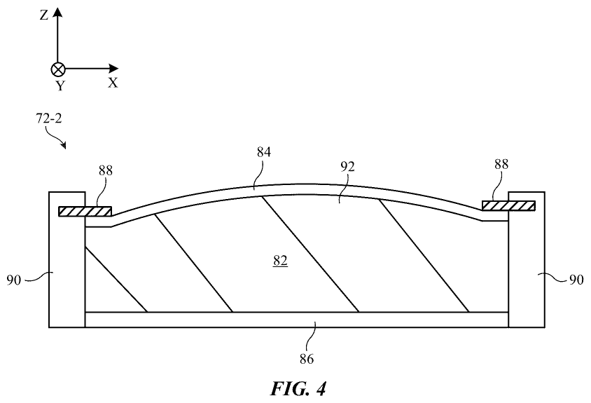

FIG. 4 is a cross-sectional side view of adjustable fluid-filled lens element 72-2. As shown, fluid-filled chamber 82 (sometimes referred to as chamber 82, fluid chamber 82, primary chamber 82, etc.) that includes fluid 92 is interposed between lens elements 84 and 86. Lens elements 84 and 86 may sometimes be referred to as part of chamber 82 or may sometimes be referred to as separate from chamber 82. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, shape memory alloy (SMA), motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. In one example, lens element 84 is an elastomeric lens element whereas lens element 86 is a rigid lens element.

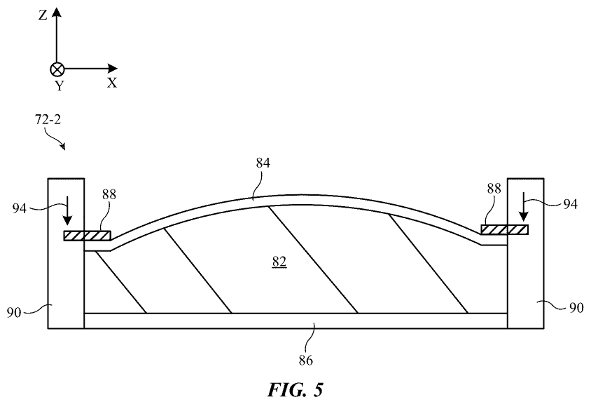

Elastomeric lens elements (e.g., lens element 84 in FIGS. 4 and 5) may be formed from a natural or synthetic polymer that has a low Young's modulus for high flexibility. For example the elastomeric membrane may be formed from a material having a Young's modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young's modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements (e.g., lens clement 86 in FIGS. 4 and 5) may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young's modulus that is greater than greater than 25 GPa, greater than 30 GPa, greater than 40 GPa, greater than 50 GPa, etc.

In addition to lens elements 84 and 86 and fluid-filled chamber 82, lens module 72-2 also includes a lens shaping element 88. Lens shaping element 88 may be coupled to one or more actuators 90 (e.g., positioned around the circumference of the lens module). The lens shaping clement 88 may also be coupled to lens element 84. Actuators 90 may be adjusted to position lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power of lens module 72-2) may be adjusted. An example of actuators 90 and lens shaper 88 being used to change the curvature of lens element 84 in FIG. 5. As shown, lens shaper 88 is moved in direction 94 by actuators 90. This results in lens element 84 having more curvature in FIG. 5 than in FIG. 4.

The example of tunable lens element 72-2 being a fluid-filled lens element is merely illustrative. In general, tunable lens element 72-2 may be any desired type of tunable lens element with adjustable optical power.

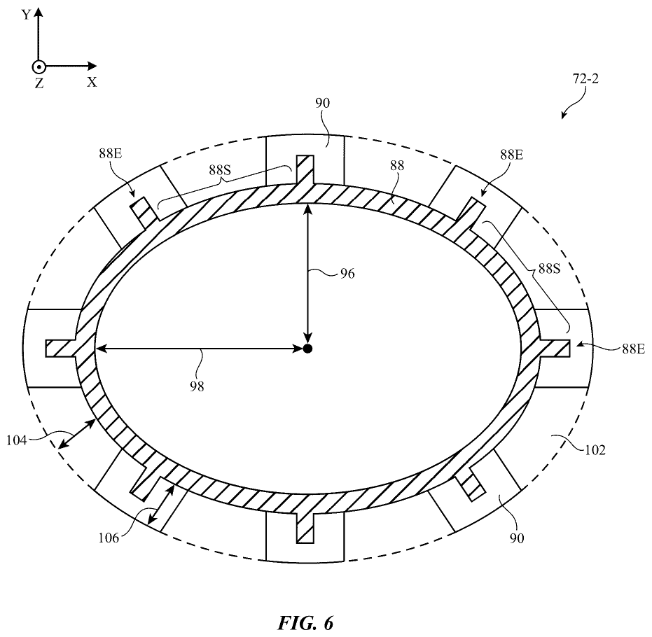

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping clement may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping clement. Distance 96 and 98 may be less than 100 millimeters, less than 60 millimeters, less than 40 millimeters, less than 30 millimeters, greater than 10 millimeters, greater than 20 millimeters, between 10 and 50 millimeters, etc.

Lens shaping element 88 has a plurality of tabs 88E that extend from the main portion of the lens shaping element. The tabs 88E (sometimes referred to as extensions 88E, actuator points 88E, etc.) may each be coupled to a respective actuator 90. Each actuator may selectively move its respective extension 88E up and down (e.g., in the Z-direction) to control the position of tab 88E in the Z-direction. In other words, actuator 90 is a linear actuator.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) allows for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young's modulus for high flexibility, as discussed above in greater detail) or semi-rigid (e.g., formed from a semi-rigid material that is stiff and solid, but not inflexible, as discussed above in greater detail). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal). The rigidity of lens shaping clement 88 may be selected such that the lens shaping element assumes desired target shapes when manipulated by the actuators around its perimeter.

One or more structures such as a lens housing 102 (sometimes referred to as housing 102, lens chassis 102, chassis 102, support structure 102, etc.) may also be included in tunable lens element 72-2. Actuators 90 may be positioned within lens housing 102. Lens housing 102 may optionally define a portion of the fluid-filled chamber 82.

Lens housing 102 may have a width 104. Each actuator 90 may have a width 106. In some devices, it may be desirable for the magnitude of width 104 to be small (e.g., to achieve a thin bezel with a target aesthetic appearance). However, the magnitude of width 104 need to be greater than or equal to the magnitude of width 106 (of actuators 90) to accommodate actuators 90. In other words, the width of the actuators may be a limiting factor in the width of the lens housing.

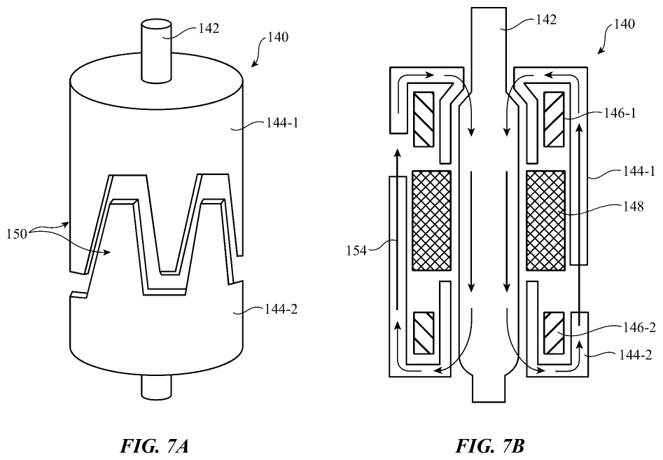

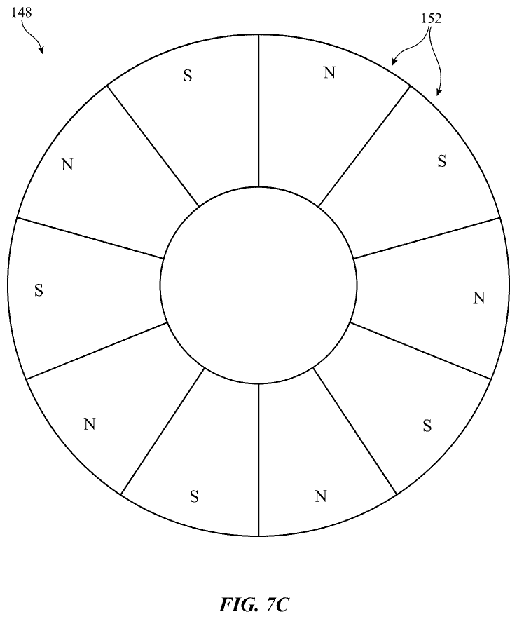

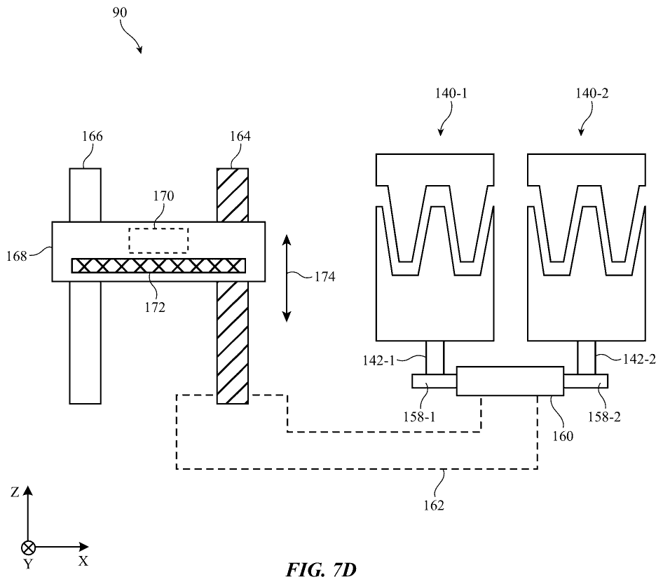

To mitigate the width 106 of actuator 90, the actuator may include a stepper motor with two motor subassemblies that each have a ring-shaped magnet that is interposed between two coils. With this type of arrangement (shown in FIGS. 7A-7E), the maximum width 106 of the actuator may be less than 3 millimeters, less than 2.5 millimeters, greater than 1 millimeter, between 2.0 and 2.5 millimeters, etc.

FIG. 7A is a perspective view of an illustrative motor subassembly, FIG. 7B is a cross-sectional side view of the illustrative motor subassembly of FIG. 7A, FIG. 7C is a top view of an illustrative ring-shaped magnet that may be used in the motor subassembly shown in FIGS. 7A and 7B, and FIG. 7D is a perspective view of a stepper motor 90 that includes two motor subassemblies of the type shown in FIGS. 7A and 7B.

As shown in FIG. 7A, motor subassembly 140 may include a central rotor 142 that extends through chassis 144-1 and 144-2 (sometimes referred to as yokes 144) parallel to an axis. Each chassis has teeth 150 that interlock with the teeth of the opposing chassis. In other words, the teeth of chassis 144-1 extend into the gaps between the teeth of chassis 144-2. Simultaneously, the teeth of chassis 144-2 extend into the gaps between the teeth of chassis 144-1.

As shown in FIG. 7B, rotor 142 may extend through a ring-shaped magnet in addition to chassis 144-1 and 144-2. Ring-shaped magnet 148 may be a multipole magnet with a plurality of sections (sometimes referred to as segments) having alternating polarity. FIG. 7C shows an example where magnet 148 has ten sections 152 that alternate between a first polarity (denoted by the ‘N’ in FIG. 7C) and a second, opposite polarity (denoted by the ‘S’ in FIG. 7C) around the circumference of the magnet. Sections 152 may sometimes be referred to as radial sections.

Each chassis may have a number of teeth that is equal to the number of sections in the magnet divided by two. As an example, when there are ten sections in magnet 148 then chassis 144-1 may have five teeth and five corresponding gaps between the teeth. Similarly, chassis 144-2 may have five teeth and five corresponding gaps between the teeth. Accordingly, the sum of the number of teeth in chassis 144-1 and chassis 144-2 is equal to the number of sections 152 in magnet 148.

Returning to FIG. 7B, the motor subassembly 140 may also include a first coil 146-1 and a second coil 146-2. Each coil may be formed from a conductive material (e.g., copper) and may have any desired number of turns (e.g., more than 20 turns, more than 40 turns, more than 80 turns, more than 100 turns, less than 100 turns, between 80 turns and 100 turns, etc.). The coils may be operated in unison, meaning that a current applied to coil 146-1 is also applied to coil 146-2 (e.g., with the same magnitude and direction). Rotor 142 extends through respective openings in chassis 144-1, chassis 144-2, coil 146-1, coil 146-2, and magnet 148,

Magnet 148 is interposed between coils 146-1 and 146-2 along a direction parallel to the elongated direction of the rotor. Magnet 148 does not overlap coil 146-1 within a plane that is orthogonal to the elongated direction of the rotor and magnet 148 does not overlap coil 146-2 within a plane that is orthogonal to the elongated direction of the rotor.

As shown in FIG. 7D, the stepper motor may include a first motor subassembly 140-1 and a second motor subassembly 140-2. Each motor subassembly may have the structure depicted in FIGS. 7A and 7B with a respective rotor 142. Each rotor 142 may be connected to a respective gear 158 and each gear 158 may be connected to a common gear 160. In other words motor subassembly 140-1 includes a rotor 142-1 that is connected to a gear 158-1. Gear 158-1 is connected to common gear 160 and sub assembly 140-1 may turn rotor 142-1 and gear 158-1 to cause gear 160 to turn. Motor subassembly 140-2 includes a rotor 142-2 that is connected to a gear 158-2. Gear 158-2 is connected to common gear 160 and sub assembly 140-2 may turn rotor 142-2 and gear 158-2 to cause gear 160 to turn.

During operation of stepper motor 90, the coils may be operated according to an operating sequence. Motor subassemblies 140-1 and 140-2 may work in conjunction to rotate the central gear 160. In particular, the two subassemblies 140-1 and 140-2 are out of phase such that they take turns providing torque to central gear 160. First, a current is applied to the coils of subassembly 140-1, causing rotor 142-1 to rotate into alignment with the field, which in turn brings rotor 142-2 of subassembly 140-2 out of alignment (since they are coupled by the central gear). Second, a current is applied to the coils of subassembly 140-2, causing rotor 142-2 to rotate into alignment with the field, which in turn brings rotor 142-1 of subassembly 140-1 out of alignment. Ultimately, each assembly is alternatively excited with currents in order to rotate the central gear. The order of the sequence of currents applied to the subassemblies may be used to rotate central gear 160 either clockwise or counterclockwise.

It is noted that when a current is applied to coils 146-1 and 146-2, a magnetic field is induced as indicated by magnetic field lines 154 in FIG. 7B. As shown by the magnetic field lines, the magnetic loop induced by the current applied to the coils may include rotor 142, chassis 144-1 and chassis 144-2. Because the rotor is part of the magnetic field return path during operation of motor 90, the rotor may be formed from a material with a relatively high magnetic saturation. For example, the rotor may be formed from an alloy of cobalt, iron, and vanadium (e.g., cobalt steel). As one example, the rotor may include 49% iron, 49% cobalt, and 2% vanadium. The magnetic saturation point for the material used to form the rotor may be greater than 1 tesla (T), greater than 1.5 T, greater than 2 T, less than 3 T, between 2 T and 3 T, etc.

Each motor subassembly 140 in the stepper motor of FIG. 7D may have a maximum diameter (width) of less than 3 millimeters, less than 2.5 millimeters, greater than 1 millimeter, between 2.0 and 2.5 millimeters, etc.

FIG. 7D additionally shows how gear 160 may be coupled to screw 164 by one or more additional gears 162. In other words, rotation of gear 160 by motor subassemblies 140-1 and 140-2 causes screw 164 to rotate. A nut 168 may be attached between screw 164 and guide rod 166. Guide rod 166 is a straight vertical pole that is inserted through an opening in nut 168. The guide rod may prevent nut 168 from spinning when screw 164 is spun by gear(s) 162. Nut 168 may have threads that mate with the threads of screw 164. Because the nut cannot spin (due to the guide rod), the nut will travel up and down along direction 174 (e.g., parallel to the Z-axis) when screw 164 is rotated.

Nut 168 may further include an opening 170 (sometimes referred to as recess 170, slot 170, etc.) that receives a respective extension 88E of lens shaping clement 88. Opening 170 may be defined at least partially by nut 168 or another component that is fixed to nut 168. The extension 88E is therefore moved up and down along direction 174 in unison with nut 168 in response to rotation of screw 164. In other words, the position of slot 170 relative to nut 168 is fixed. Rotation of screw 164 in a first direction (e.g., clockwise) may cause nut 168 and extension 88E to be moved in a second direction (e.g., the positive Z-direction) whereas rotation of screw 164 in a third direction (e.g., counter-clockwise) that is opposite the first direction may cause nut 168 and extension 88E to be moved in a fourth direction (e.g., the negative Z-direction) that is opposite the third direction.

In general, each actuator may act as a point force that applies force only in one direction (e.g., parallel to the Z-axis). To prevent unintentionally applying torque or other force to the lens shaping clement 88, slot 170 may be larger than extension 88E. This provides room for tab 88E to rotate within the slot (preventing torque from being applied to the lens shaper). Additionally, the extension 88E may slide in and out of the slot to prevent unintentionally stretching the lens shaping element. A low stiffness elastomer may optionally be included in slot 170 to prevent significant backlash in embodiments where force is applied to tab 88E in multiple directions.

Actuator 90 may include a sensor that is used to sense the position of nut 168 (and therefore extension 88E in sot 170). The sensor may be, as an example, a capacitive sensor. The sensor may be used to determine the location of nut along direction 174 (e.g., in the Z-direction). In some embodiments, the sensor may be able to determine the precise position of nut 168 along the Z-axis. In other embodiments, the sensor (sometimes referred to as a homing sensor) may be able to determine when the nut 168 is at a given home position. In this case, the motor may move the nut until the sensor is identified as being present at the given home position. Future movement of the nut is then known to be relative to the given home position.

The location sensor may include an electrode 172 that is attached to nut 168. As shown in FIG. 7D, electrode 172 may have the shape of a horizontal bar. As shown in the top view of FIG. 7E, electrode 172 may be positioned opposite one or more electrodes 174 that are positioned on an interior wall of actuator housing 176. Motor subassemblies 140-1 and 140-2 (as well as screw 164, guide rod 166, nut 168, etc.) may be enclosed within actuator housing 176.

The top view of FIG. 7E shows an additional perspective of extension 88E of lens shaping structure 88 extending into recess 170 of nut 168. FIG. 7E additionally show how guide rod 166 and screw 164 extend through respective openings in nut 168.

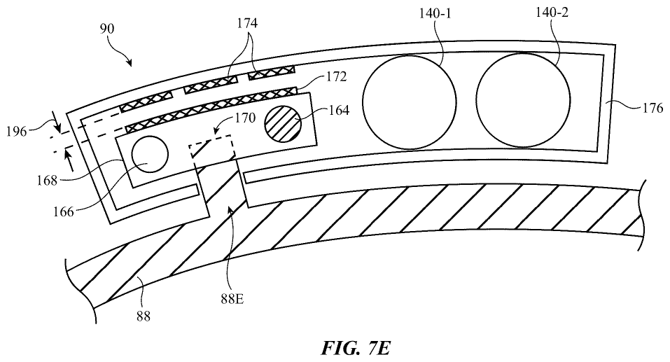

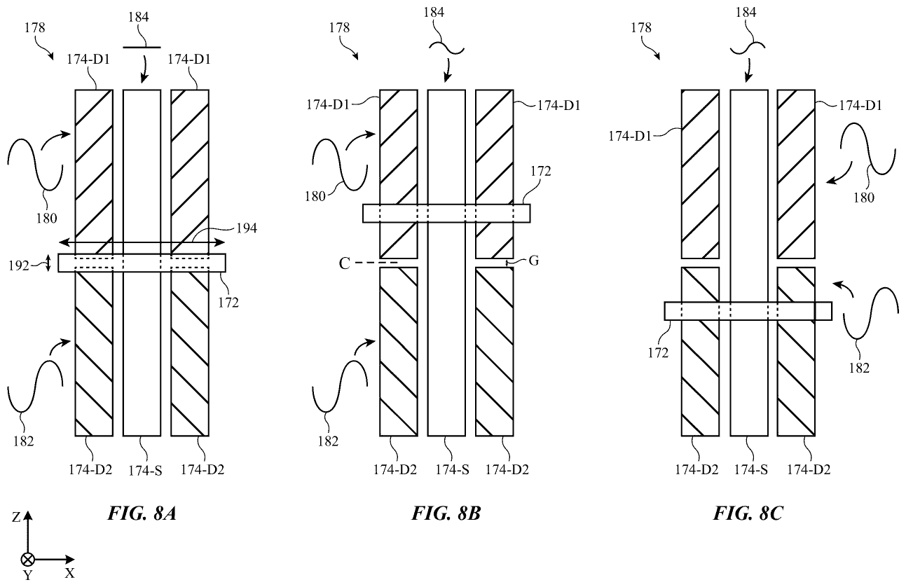

FIGS. 8A-8C are side views of an illustrative position sensor 178 that may be used to sense the position of nut 168 in actuator 90. As shown in FIG. 8A, position sensor 178 may include electrodes 174-D1, 174-D2, and 174-S that are positioned on the wall of housing 176 (as shown in FIG. 7E). Position sensor 178 (sometimes referred to as homing sensor 178) also includes electrode 172 (e.g., that is positioned on nut 168 and moves in unison with nut 168). Each one of electrodes 172, 174-D1, 174-D2, and 174-S may be formed from a conductive material such as copper, aluminum, nickel, gold, silver, etc. Each electrode may optionally be plated/coated with an additional material (e.g., a gold plating or coated with a passivation layer).

As shown in FIG. 8A, the electrodes 174 on the actuator housing may include a first pair of drive electrodes 174-D1, a second pair of drive electrodes 174-D2, and a sense electrode 174-S. Sense electrode 174-S is interposed between first and second drive electrodes 174-D1. Sense electrode 174-S is interposed between first and second drive electrodes 174-D2. The first and second drive electrodes 174-D1 may be driven with the same signal 180 (e.g., a sine wave with a first phase). The first and second drive electrodes 174-D2 may be driven with the same signal 182 (e.g., a sine wave with a second, opposite phase). Signals 182 and 180 may be opposite signals (e.g., the sine wave of signal 182 is 180 degrees out of phase with the sine wave of signal 180).

The electrode 172 on nut 168 may sometimes be referred to as a wiper. FIG. 8B shows a center C between drive electrodes 174-D1 and 174-D2. The homing sensor 178 may determine position of wiper 172 relative to center C.

As shown in FIG. 8A, when wiper 172 is centered between electrodes 174-1 and 174-2 (e.g., aligned with center C), both signals 180 and 182 contribute equally to the signal on sense electrode 174-S. As shown in FIG. 8A, the resulting signal 184 is a flat line (because signals 180 and 182 cancel each other out).

As shown in FIG. 8B, when wiper 172 is shifted upwards (e.g., in the positive Z-direction) such that the wiper overlaps drive electrodes 174-D1 but not drive electrodes 174-D2, signal 180 dominates the contribution to the signal 184 on sense electrode 174-S. As shown in FIG. 8B, the resulting signal 184 is a sine wave following the phase of signal 180 (because signal 180 contributes more to signal 184 than signal 182).

As shown in FIG. 8C, when wiper 172 is shifted downwards (e.g., in the negative Z-direction) such that the wiper overlaps drive electrodes 174-D2 but not drive electrodes 174-D1, signal 182 dominates the contribution to the signal 184 on sense electrode 174-S. As shown in FIG. 8C, the resulting signal 184 is a sine wave following the phase of signal 182 (because signal 182 contributes more to signal 184 than signal 180).

Homing sensor 178 of FIGS. 8A-8C is therefore able to determine when wiper 172 is centered between electrodes 174-D1 and 174-D2 (e.g., by determining when signal 184 is a flat line). During homing operations, when homing sensor 178 determines that the signal on sense electrode 174-S matches the phase of signal 180 on drive electrodes 174-D1, nut 168 and wiper 172 may be moved downwards until the output signal is flat. During homing operations, when homing sensor 178 determines that the signal on sense electrode 174-S matches the phase of signal 182 on drive electrodes 174-D2, nut 168 and wiper 172 may be moved upwards until the output signal is flat. The output from sense electrode 174-S is therefore used as feedback to center wiper 172 and nut 168 at the known location of center C.

For electrodes 174, the length of the electrode may be defined as parallel to the direction of movement of wiper 172 and the width of the electrode may be defined as perpendicular to the direction of movement of wiper 172. For electrode 172, the length 194 of the electrode may be defined as perpendicular to the direction of movement of wiper 172 and the width 192 of the electrode may be defined as parallel to the direction of movement of wiper 172.

The lengths of electrodes 174-D1, 174-D2, and 174-S are therefore parallel. The length of electrode 172 is orthogonal to the lengths of electrodes 174-D1, 174-D2, and 174-S. The magnitude of width 192 may be greater than 50 microns, greater than 100 microns, greater than 200 microns, less than 500 microns, less than 300 microns, less than 200 microns, between 100 microns and 300 microns, etc. The magnitude of length 194 may be greater than 1000 microns, greater than 2000 microns, greater than 3000 microns, less than 3000 microns, less than 2500 microns, less than 2000 microns, between 2000 microns and 2500 microns, etc. The width of each one of electrodes 174-D1, 174-D2, and 174-S may be greater than 200 microns, greater than 500 microns, greater than 1000 microns, greater than 2000 microns, greater than 3000 microns, greater than 4000 microns, less than 4000 microns, less than 3000 microns, less than 2000 microns, less than 1000 microns, less than 500 microns, between 500 microns and 1000 microns, etc. The length of each one of electrodes 174-D1 and 174-D2 may be greater than 500 microns, greater than 1000 microns, greater than 2000 microns, greater than 3000 microns, greater than 4000 microns, less than 4000 microns, less than 3000 microns, less than 2000 microns, less than 1000 microns, less than 500 microns, between 500 microns and 1000 microns, etc. The length of electrode 174-S may be greater than 1000 microns, greater than 2000 microns, greater than 3000 microns, greater than 4000 microns, less than 4000 microns, less than 3000 microns, less than 2000 microns, less than 1000 microns, between 1000 microns and 2000 microns, between 1000 microns and 4000 microns, between 3000 microns and 4000 microns, etc.

As shown in FIG. 8B, adjacent electrodes 174 on housing 176 may be separated by a gap G that is greater than 10 microns, greater than 50 microns, greater than 100 microns, greater than 200 microns, less than 500 microns, less than 300 microns, less than 200 microns, less than 100 microns, less than 50 microns, less than 30 microns, etc.

In general, performance of homing sensor 178 may be improved when electrode 172 has a width 192 that is small and a length 194 that is long (e.g., increasing the aspect ratio of electrode 172 may improve performance of sensor 178). Performance of homing sensor 178 may also be improved when the magnitude of gap 196 between electrodes 174 and electrode 172 (shown in FIG. 7E) is relatively low. The magnitude of gap 196 may be less than 500 microns, less than 300 microns, less than 150 microns, greater than 50 microns, greater than 150 microns, between 50 microns and 300 microns, etc.

The homing sensor of FIGS. 8A-8C may be robust to temperature changes. Due to the homing sensor including at least two electrodes driven with opposing signals, changes in capacitance caused by changes in temperature cancel out.

Moreover, the homing sensor of FIGS. 8A-8C is robust to misalignments (e.g., translations and rotations of wiper 172 relative to electrodes 174 may have minimal impact on performance of sensor 178). As an example, including a drive electrode 174-D1 on either side of sense electrode 174-S may ensure that rotations of wiper 172 (e.g., where one side of the wiper is closer to the housing wall and electrodes 174 than the other side of the wiper) have minimal impact on performance of sensor 178.

There are numerous ways to form electrodes 174 of homing sensor 178. In one example, electrodes 174 may be formed by a copper pattern on a printed circuit board that is attached to actuator housing 176 (e.g., with an adhesive layer). In another example, electrodes 174 may be formed by metal that is plated directly to housing 176 (e.g., using laser direct structuring). In another example, a molding process may be used to mold electrodes 174 as inserts into a plastic housing 176.

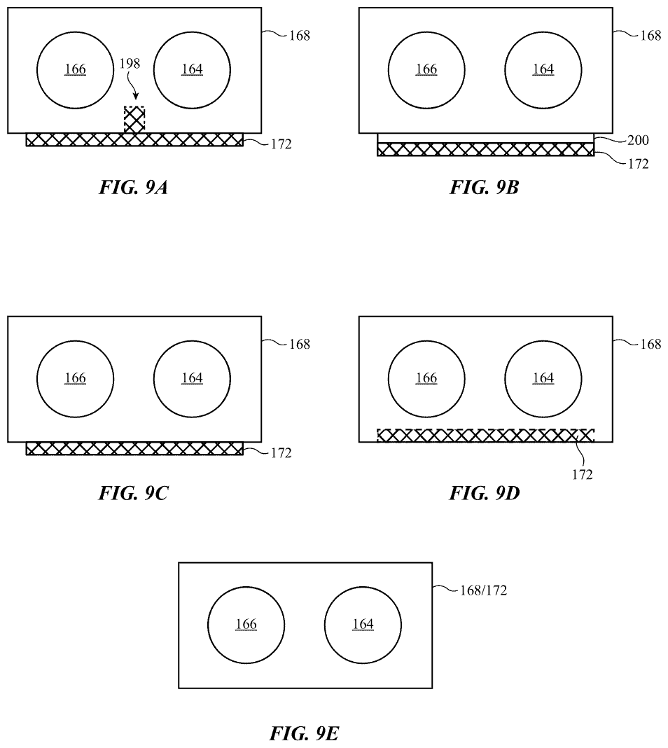

FIGS. 9A-9E show various options for forming electrode 172 on nut 168. In the example of FIG. 9A, electrode 172 is formed from a T-shaped piece of metal that is inserted into a slot 198 in nut 168. The example in FIG. 9A of electrode 172 having a T-shape with a single protrusion that extends into slot 198 is merely illustrative. Electrode 172 may optionally have two or more protrusions that extend into respective slots 198 on nut 168. When multiple protrusions are included in electrode 172, different protrusions may optionally have the same dimensions or different dimensions. As yet another example, the entire length of electrode 172 may extend into a corresponding slot in nut 168.

Adhesive may be included in slot 198 to fix the electrode in the slot. In the example of FIG. 9B, electrode 172 is a flat piece of metal (e.g., a conductive bar) that is attached to nut 168 using adhesive layer 200. In the example of FIG. 9C, electrode 172 is plated directly onto the surface of nut 168 (e.g., using laser direct structuring). In the example of FIG. 9D, a molding process may be used to mold nut 168 over electrode 172. In the example of FIG. 9E, the material of nut 168 may be conductive. Alternatively, nut 168 may be formed from a dielectric material with a high dielectric constant (e.g., a dielectric constant that is greater than 5, greater than 10, etc.). In this way, nut 168 itself serves as electrode 172 for homing sensor 178.

In FIGS. 8A-8C, the homing sensor includes a sense electrode 174-S in addition to wiper 172. Wiper 172 in FIGS. 8A-8C is floating (e.g., not shorted to another conductive component). The wiper is capacitively coupled to both the drive electrodes and sense electrode 174-S, effectively providing the sensing signal to sense electrode 174-S. This example is merely illustrative. In another possible arrangement, electrode 172 on nut 168 may serve as the sense electrode and sense electrode 174-S may be omitted. To enable electrode 172 to serve as the sense electrode, electrode 172 may be shorted to additional sensing circuitry on a circuit board (e.g., via a wire or flexible printed circuit). As one example, nut 168 and one or both of screw 164 and guide rod 166 may be formed from a conductive material. The conductive screw and/or guide rod may be electrically connected to additional sensing circuitry. In this way, electrode 172 may be shorted to the additional sensing circuitry on a circuit board through nut 168 and guide rod 166 and/or screw 164.

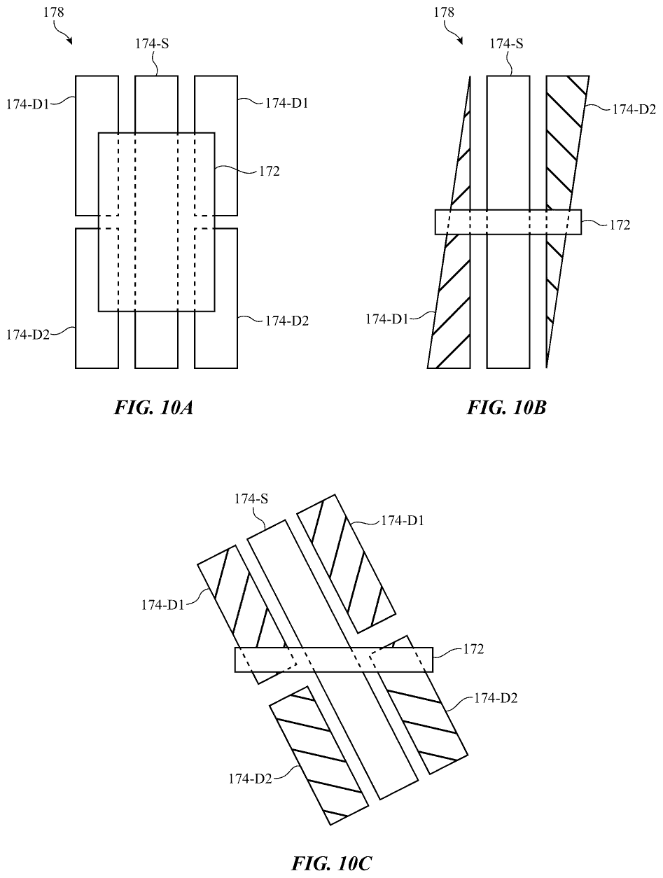

In the arrangement of FIGS. 8A-8C, position sensor 178 may be used to adjust nut 168 and electrode 172 (and accordingly, the extension 88E of lens shaping element 88) to be in a home position. A position sensor of this type may have a sharp transition region in the output signal as the wiper moves from too high (e.g., higher than the center C as in FIG. B) to too low (e.g., lower than the center C as in FIG. 8C) or vice versa. With this arrangement, the precision of placing the nut in the home position is high but there is little to no resolution for measuring the position of electrode 172 (and nut 168) outside of the home position. Alternatively, the position sensor may instead be designed to provide resolution across the entire actuator range such that the position of electrode 172 within the range may be determined. FIGS. 10A-10C show arrangements for position sensors of this type.

FIG. 10A shows an example with a similar arrangement as in FIGS. 8A-8C. However, in FIG. 10A the size of wiper 172 is increased. Accordingly, the wiper will always be overlapping both the drive electrodes 174-D1 and the drive electrodes 174-D2. When the wiper and centered and the overlap amount is equal, the signal at sense electrode 174-S will be flat (due to the signals from 174-D1 and 174-D2 cancelling out). As the wiper gradually shifts upwards, the signal at sense electrode 174-S will gradually shift to more closely match the signal at drive electrodes 174-D1. As the wiper gradually shifts downwards, the signal at sense electrode 174-S will gradually shift to more closely match the signal at drive electrodes 174-D2. The signal at sense electrode 174-S therefore may be used to determine the position of wiper 172 within the range of actuator 90.

In FIG. 10B, a sense electrode 174-S is interposed between a first drive electrode 174-D1 and a second drive electrode 174-D2. The drive electrodes 174-D1 and 174-D2 each have a right triangular shape. The shape and footprint of drive electrodes 174-D1 and 174-D2 is the same. However, the base of the triangle for electrode 174-D2 is aligned with the top of sense electrode 174-S whereas the base of the triangle for electrode 174-D1 is aligned with the bottom of sense electrode 174-S. When the wiper is aligned with the center C of sense electrode 174-S, the width of drive electrodes 174-D1 and 174-D2 may be approximately equal and the signal at sense electrode 174-S will be flat (due to the signals from 174-D1 and 174-D2 cancelling out). As the wiper gradually shifts upwards, the signal at sense electrode 174-S will gradually shift to more closely match the signal at drive electrode 174-D2 (due to more overlap with drive electrode 174-D2 than drive electrode 174-D1). As the wiper gradually shifts downwards, the signal at sense electrode 174-S will gradually shift to more closely match the signal at drive electrodes 174-D1 (due to more overlap with drive electrode 174-D1 than drive electrode 174-D2). The signal at sense electrode 174-S therefore may be used to determine the position of wiper 172 within the range of actuator 90.

In FIG. 10C, a sense electrode 174-S has a first portion that is interposed between a first pair of drive electrodes 174-D1 and a second portion that is interposed between a second pair of drive electrodes 174-D2. The wiper 172 has a length that is at a non-parallel, non-orthogonal angle relative to the lengths of electrodes 174-D1, 174-D2, and 174-S. The operation of the sensor of FIG. 10C is similar to the sensor of FIG. 10B.

The foregoing is merely illustrative and various modifications can be made to the described embodiments. The foregoing embodiments may be implemented individually or in any combination.

What is claimed is:

1. An actuator comprising:
a housing;
a screw in the housing;
a nut in the housing and aligned with the screw;
a stepper motor in the housing and configured to rotate the screw to adjust a position of the nut; and
a capacitive sensor configured to sense a position of the nut, wherein the capacitor sensor comprises a first electrode on the nut and at least one electrode on the housing.

2. The actuator defined in claim 1, wherein the at least one electrode on the housing comprises at least one drive electrode and a sense electrode and wherein the first electrode is capacitively coupled to both the at least one drive electrode and the sense electrode.

3. The actuator defined in claim 2, wherein the at least one drive electrode comprises a first drive electrode that is driven with a first signal and a second drive electrode that is driven with a second signal that is opposite the first signal.

4. The actuator defined in claim 3, wherein the at least one drive electrode comprises a third drive electrode that is driven with the first signal and a fourth drive electrode that is driven with the second signal.

5. The actuator defined in claim 4, wherein the sense electrode has a first portion that is interposed between the first and third drive electrodes and a second portion that is interposed between the second and fourth drive electrodes.

6. The actuator defined in claim 1, wherein the first electrode is attached to the nut with an adhesive layer.

7. The actuator defined in claim 1, wherein the first electrode has a protrusion that extends into a corresponding slot in the nut.

8. The actuator defined in claim 1, wherein the first electrode is plated directly on the nut.

9. The actuator defined in claim 1, wherein the nut comprises plastic that is molded over the first electrode.

10. A tunable lens comprising a lens element and an actuator configured to adjust a first position of the lens element, wherein the actuator comprises:
a screw;
a nut aligned with the screw; and
first and second motor subassemblies configured to rotate the screw, wherein the first position of the lens element and a second position of the nut are adjusted when the screw is rotated and wherein each one of the first and second motor subassemblies comprises:
a ring-shaped magnet with a plurality of sections having alternating polarity;
a first coil; and
a second coil, wherein the ring-shaped magnet is interposed between the first and second coils.

11. The tunable lens defined in claim 10, wherein the lens element is a flexible lens element and wherein the tunable lens further comprises:
a lens shaping structure that is coupled to the flexible lens element.

12. The tunable lens defined in claim 11, wherein the lens shaping structure comprises a tab that extends into a slot in the actuator.

13. The tunable lens defined in claim 12, wherein the slot is formed at least partially by the nut and wherein a third position of the slot changes in unison with the second position of the nut.

14. The tunable lens defined in claim 13, wherein the actuator further comprises:
a guide rod that is parallel to the screw, wherein the nut has a first opening that is aligned with the screw and a second opening that is aligned with the guide rod.

15. The tunable lens defined in claim 10, wherein the actuator further comprises:
one or more gears that are rotated by the first and second motor subassemblies to rotate the screw.

16. The tunable lens defined in claim 10, wherein the actuator further comprises:
a housing for the screw, the nut, and the first and second motor subassemblies; and
a homing sensor that comprises a first electrode on the nut and a second electrode on the housing.

17. The tunable lens defined in claim 16, wherein the homing sensor comprises a third, fourth, fifth, and sixth electrodes on the housing, wherein the second and third electrodes are drive electrodes that are driven with a first signal, wherein the fourth and fifth electrodes are drive electrodes that are driven with a second signal that is opposite the first signal, and wherein the sixth electrode is a sense electrode.

18. The tunable lens defined in claim 17, wherein each one of the first and second motor subassemblies further comprises:
a first chassis with a first plurality of teeth separated by a first plurality of gaps; and
a second chassis with a second plurality of teeth separated by a second plurality of gaps.

19. The tunable lens defined in claim 18, wherein the first plurality of teeth extends into the second plurality of gaps and wherein the second plurality of teeth extends into the first plurality of gaps.

20. An actuator comprising:
a housing;
a screw enclosed by the housing;
a nut enclosed by the housing and aligned with the screw;
a stepper motor enclosed by the housing and configured to rotate the screw to adjust a position of the nut; and
a homing sensor configured to sense when the nut is at a known home position, wherein the homing sensor comprises a conductive bar that moves in unison with the nut and at least one electrode on a wall of the housing.
